(19) United States
(12) Patent Application Publication
(10) Pub. No.: US 2025/0138785 A1
(43) Pub. Date: May 1, 2025

(54) METHODS, DEVICES, AND SYSTEMS FOR THE GATHERING, PROCESSING, AND DISTRIBUTION OF ENTROPY-RELATED METRICS

(71) Applicant: Quside Technologies S.L., Barcelona (ES)

(72) Inventors: Carlos Abellán Sánchez, Barcelona (ES); Marc Romeu Casas, Girona (ES); Fernando de la Iglesia Medina, Madrid (ES); José Ramón Martínez Saavedra, Barcelona (ES)

(21) Appl. No.: 18/927,392

(22) Filed: Oct. 25, 2024

(30) Foreign Application Priority Data
Oct. 25, 2023 (EP) 23383094
Apr. 17, 2024 (EP) 24170894

(51) Int. Cl. G06F 7/58; H04L 9/08; H04L 9/32

(52) U.S. Cl. CPC G06F 7/588; H04L 9/0869; H04L 9/3263

(57) ABSTRACT

An apparatus, comprising: an entropy source, a computing device, a physical entropy monitoring device, wherein said entropy monitoring device is configured to measure a physical parameter of said entropy source, and at least one of said computing device or said physical entropy monitoring device is configured to compute an entropy quality metric at least based on said physical parameter of said entropy source. Also, a method for enhancing trust in certificate generation, a smartphone, and a communication network.

### CROSS-REFERENCE TO RELATED APPLICATIONS

This application claims priority to European Patent Application No. EP 23383094.2 filed on Oct. 25, 2023 and to European Patent Application No. EP 24170894.0 filed on Apr. 17, 2024, the contents of both of which are hereby incorporated by reference in their entireties.

### BACKGROUND

Security has always been a crucial aspect of communication. In the past, communication security was important for protecting messages from being intercepted or decoded by unauthorized entities. Nowadays, with the widespread use of digital communication networks, the need for secure communication has become even more crucial to prevent sensitive information from being accessed by unauthorized parties, as these digital networks transmit a lot of sensitive information, such as personal data, health data, and financial details.

There are many ways this information can be intercepted or compromised if proper security measures are not in place, so communication networks implement devices such as firewalls, systems such as Virtual Private Networks (VPNs), spam/malware filters, or intrusion detection systems, and methods such as Secure Sockets Layer (SSL) and Transport Layer Security (TLS) encryption protocols, end-to-end encryption (E2EE), two-factor authentication, key exchange protocols, backups, homomorphic encryption, or network segmentation, to prevent these cyberattacks and minimize their effect if they happen.

Additionally, beyond encryption, data integrity, authentication, and identity are critical aspects of cybersecurity nowadays, which are reflected in applications such as Digital Signatures, X.509 certificates for identification, and blockchain, among others.

Most, if not all, of these examples, rely on cryptography as a key enabling component of their activity. Cryptography is the practice of secure communication in the presence of third parties, and it is used to protect the confidentiality and integrity of information. This is achieved by using mathematical algorithms to scramble information so that it can only be deciphered by the intended recipient, preventing interception, access, and tampering by unauthorized parties, such as hackers or cybercriminals.

These cryptographic algorithms rely on two building blocks: on the one hand, the mathematical algorithm to perform the scrambling: on the other hand, the entropy required to choose the way information will be scrambled. Entropy refers to the unpredictability of a system, and in the context of cryptography, it provides an unpredictable way to scramble information using these algorithms by means of random numbers. Without entropy, it would be possible to predict the outcome of the encryption and decryption processes, making the encryption useless. In other words, entropy acts as the main guarantee of the proper function of cryptographic algorithms. The use of entropy in cryptographic algorithms helps to ensure that information is transmitted securely and cannot be deciphered by unauthorized parties, even if they try to analyze the encrypted data using various methods.

However, while there are many metrics that are monitored to preserve and respond to threats in upper layers (such as firewalls, network components, and spam filters), the entropy quality in systems and networks is not equally treated in communication networks and processing devices. Besides, entropy is a complex concept that, even being difficult to measure and manage, is an essential component of secure communication, as proper entropy generation and dissemination are necessary for the security of a network to be guaranteed.

Failures in the correct distribution of entropy within a communications network can have catastrophic consequences for its proper functioning. The most obvious of all are associated with the security vulnerabilities that arise, since encryption algorithms depend directly on the quality of entropy and become weaker when it is scarce. All this can lead to compromise both the confidentiality of data transmitted over the network and the risk of unauthorized access to the network.

In addition, the loss or lack of entropy can produce a whole series of additional undesirable effects, such as synchronization problems, data corruption, or congestion of the communications channel, all of which have a direct and far-reaching impact on the quality of service, degrading it irremediably and incorrigibly.

Furthermore, without awareness of entropy failure, identifying the root cause of communication problems becomes challenging. Network providers and users struggle to diagnose issues related to security breaches, data corruption, or performance degradation. Without proper entropy metrics in place, this can lead to prolonged troubleshooting processes, increased downtime, and inefficient resource utilization.

Therefore, it is important to develop metrics and tools to monitor and manage entropy in a network, regardless of the complexity of the task, to ensure the reliability and security of computer systems and communication networks.

Current methods used for entropy monitoring focus mostly on a posteriori analysis. In other words, once a random data sequence has been generated, it is subjected to a series of statistical tests to determine whether it qualifies as a suitable entropy string. These tests, as they apply to the random stream, are suited to be used with any kind of random number generation scheme, including algorithmic pseudo-random number generators (PRNGs).

Other approaches, generally more focused on the physical origin of the entropy itself, include a priori estimation of the entropy bounds, providing physical guarantees that the entropy source device is in such a state that the bit strings obtained from it are valid. For example, [https://arxiv.org/abs/1506.02712] shows the application of these methods to determine that a given quantum system is generating high-quality random numbers

Despite their usefulness, these methods have very limited applicability today. Mainly due to their complexity and high cost, these tests are often simplified or even skipped, which inevitably reduces their usefulness. This simplification can lead to errors in the identification of entropy problems at early stages, which can be critical for applications that depend on the reliability of entropy for security purposes. Moreover, in situations where complex calculations are performed, there is a risk that, in the worst-case scenario, the client has already consumed the entropy by the time an anomaly or failure is detected, thus compromising the security of every cryptographic primitive and workload that relied on that entropy string in the first place [https://sec.cloudapps.cisco.com/security/center/content/CiscoSecurityAdvisory/cisco-sa-asa5500x-entropy-6v9bHVYP].

Furthermore, the reliance on stochastic models for entropy estimation brings about its own set of challenges. These models are not implemented in real-time but rather are applied as one-time evaluations at the time the device is manufactured or booted up. Such an approach implicitly assumes that the conditions of the entropy source will remain stable after these checks, an assumption that does not hold in dynamic or adversarial environments, and it effectively delegates the responsibility for ongoing quality assurance to the a-posteriori analytical methods. As a result, any anomalies in the entropy source that occur during these unmonitored intervals can go undetected.

In this context, it is imperative not only to provide stakeholders with accurate entropy metrics, but also to ensure that these metrics are available in conjunction with the entropy itself. This would make it easier for users to make informed decisions while ensuring the quality and reliability of the resources they are using.

### SUMMARY

The present disclosure relates to devices and methods for generating physical metrics related to entropy generation. In some embodiments, such metrics are online and/or real-time metrics. This disclosure relates also to systems and methods for disseminating these metrics, as well as any other entropy metrics, through systems and networks. In some embodiments, these devices and methods enable the collection and analysis of these metrics, which are critical for ensuring the security of a network.

The present disclosure also relates to systems and methods for aggregating, distributing, and acting on these metrics, providing a comprehensive solution for managing the security of any kind of communications network. In some embodiments, these systems and methods are used to monitor the security of a network in real-time and take action to address, either proactively or reactively, any potential threats or vulnerabilities that are identified.

A device or system comprising at least one entropy source, at least one computing device, and at least one physical entropy monitor, the latter monitors at least one physical magnitude or metric of at least one entropy source, whose value, either in raw format or after algorithmic processing, is linked with the entropy generation quality in the past and/or present and/or future.

A device or system comprising at least one entropy source, at least one computing device, and at least one physical entropy monitor, any of the three providing information about at least one of environmental parameters, operational parameters, or identification parameters, which is combined with any of the at least one entropy source's physical metrics to provide a single value or a set of values which are linked with the entropy generation quality in the past, present, and/or future.

A device or system comprising at least one entropy source at least one computing device, and at least one physical entropy monitor, any of the three providing information about at least one of environmental parameters, operational parameters, or identification parameters, which is combined with the at least one entropy source's metrics to provide an identification stream or a fingerprint of the device.

For the sake of simplicity and clarity, embodiments of the disclosure will be simply described hereinafter as a device, although a device as described herein includes also systems comprising for instance two or more elements, apparatuses, or devices (these terms being used interchangeably), those two or more elements being functionally related to each other.

An entropy source according to the present disclosure produces random numbers by either using at least one unpredictable physical phenomenon, an algorithmic procedure, or a combination of both that may be suitable for use to that end. Preferably, the entropy source relates to at least one unpredictable physical phenomenon, with further post-processing through an algorithmic procedure that may be suitable for use to that end. The entropy source is, in some examples, configured to modify an operation thereof (either by itself or by the at least one computing device) depending on a physical state or status or entropy of the entropy source, particularly a behavior of an entropy or a physical origin of the entropy in the entropy source conditions how the entropy source is operated for production of random numbers. Examples of these include, but are not limited to, switching from an operational status or state of the entropy source to either a degraded or a non-operational status if the conditional min-entropy bound of the entropy source goes below a threshold. Examples of those thresholds include, but are not limited to, 0.50, 0.75, 0.80, 0.85, 0.90, 0.95, 0.99 bits per bit.

Preferably, at least one of the unpredictable physical phenomena will have a quantum origin. Examples of said entropy sources include—but are not limited to—phase-diffusion entropy sources and VCSEL entropy sources.

In some embodiments, the at least one computing device according to this disclosure refers to the device or system that controls the operation of the at least one entropy source. In some embodiments, the at least one computing device and the entropy source are combined into a single apparatus. Examples of combined apparatuses include—but are not limited to—personal computers, laptops, servers, workstations, supercomputers, smartphones, tablets, ASICS, CPLDs, and FPGA devices.

In some embodiments, in contrast, the at least one computing device according to this disclosure refers to the device or system that receives either the entropy, at least one of the entropy metrics, or both. In some embodiments, the at least one computing device is the consumer/client of the entropy. Examples of consumer devices include—but are not limited to—routers, firewalls, and switches, either physical or virtual. In some embodiments, the computing device also performs transformations on the entropy string, at least one of the entropy metrics, or both.

In some embodiments, the at least one computing device also computes additional entropy metrics, environmental parameters, operational parameters, and/or identification parameters. Examples of one or more of these parameters include—but are not limited to—a router adding route information to the received entropy package.

A magnitude according to the present disclosure refers to any physical or abstract property that can be measured. Examples of magnitudes include—but are not limited to—the temperature of the entropy source, its power consumption, or the number of requests per second experienced by the entropy source.

A metric according to the present disclosure includes (i) a measured magnitude of the entropy source and/or its environment: (ii) a result obtained after post-processing of any metric(s), or a combination of two or more of the above. In some embodiments, the post-processing depends on at least one of environmental parameters, operational parameters, or identification parameters. In some embodiments, the metric is provided based on a state of the device or system, and the metric is optionally a metric selected from a group of predetermined metrics so that the metric selected is one among several possible metrics depending on said state, thereby adapting the possible metrics to be used in each given situation. Examples of metrics include—but are not limited to—estimations of the conditional min-entropy bound, statistical metrics such as the running average of the generated entropy, the significance value of a statistical test, or the average number of users of the entropy source within the network.

In some embodiments, said metrics have assigned expected values and/or ranges for quality estimation. Examples of these include—but are not limited to—bitwise running averages between 0.4 and 0.6, more preferably between 0.45 and 0.55, and more preferably of 0.5, and bitwise min-entropy-per-bit bounds larger than certain thresholds including, in order of increasing preference, 0.8, 0.9, 0.95, 0.99, and 0.999. In some embodiments, these ranges are modified according to the entropy source(s) in use, the final/next destination of the entropy, or any environmental parameters, operational parameters, or identification parameters.

The present disclosure includes either one of these entropy generation devices in isolation or being integrated into a network. In some embodiments, these devices will work as entropy-as-a-service (EaaS) entities within a network. In some embodiments, these devices or systems will be integrated into network equipment, such as routers, firewalls, or switches, either physical or virtual. In some of these latter embodiments, the device that integrates at least one of the entropy generation devices or systems computes the raw metrics and/or the algorithmic processing of these, freeing the entropy generation device or system of this computational burden.

It is an object of this disclosure to provide the users of this entropy source with means to use these metrics to control the behavior of either the entropy source itself, or the networks, apparatus, or systems it provides service to. In some embodiments, the metrics are used to halt and/or reset the device if these metrics are not within an operational range of the entropy source or within an acceptable range for a specific application. In some embodiments, these metrics are used to modify and/or rearrange the network topology—for example, by removing the paths which have low entropy. In some embodiments, these metrics are used to modify routing paths or protocols—for example, by routing packets through paths of maximal entropy. In some embodiments, these metrics are used for preemptive actions on the network, such as identifying potentially dysfunctional devices.

It is an object of this disclosure that the metrics generated on the device are used as flags to detect whether the security of the network has been violated, or if there has been a potential intent to it, or if it might be relatively easy to compromise. In some embodiments, these metrics are reported to the network of a Security Operations Center (SOC), which uses them to execute any preemptive or palliative action.

It is an object of this disclosure that the metrics generated on the device are used as input of other processes within the device. Examples of these processes include, but are not limited to, one or more of: certificate generation and management, key exchange, and digital signatures. In some embodiments, these metrics are added as metadata to the requested entropy from the device. In some embodiments, these metrics are used as nonces for algorithms that leverage this entropy—for example, Deterministic Random Bit Generators (DRBGs) or certificate generators.

It is an object of this disclosure that the metrics generated on the device are further reported, either directly or post-processed, to any entity interested. In some embodiments, these reports are generated directly by the compute module of the device. In some embodiments, the metrics are transferred to a given location. In some of these latter embodiments, at the given location, the metrics are combined in a sensible way. Examples of this location include—but are not limited to—a central hub in a network, a database, a blockchain, a data lake, another computing device for further processing, a monitoring application of the network, or an end user of the network.

It is one purpose of the present disclosure to enhance the security level of any type of device and communication network which uses entropy sources at any point of their operative process. Examples of these devices and networks include, but are not limited to, datacenters, wired/wireless communication networks, either public or private, inter- or intra-node communications, IoT devices and networks, space devices and networks, critical infrastructure devices and networks, Air-Traffic Control (ATC) networks, Automatic Teller Machines (ATMs), or emergency services, among other types of networks which leverage on the disclosure.

### BRIEF DESCRIPTION OF THE DRAWINGS

To complete the description and to provide a better understanding of the disclosure, a set of drawings is provided. Said drawings form an integral part of the description and illustrate embodiments of the disclosure, which should not be interpreted as restricting the scope of the disclosure but just as examples of how the disclosure can be carried out. The drawings comprise the following figures:

FIG. 1 shows a block diagram of the prior art regarding entropy sources.

FIG. 2 shows a block diagram of an entropy source with a computing device for measuring entropy-related metrics, together with other devices and systems that integrate it.

FIG. 3 shows examples of devices and systems that integrate the entropy-related metrics.

FIG. 4 shows a potential combination of the entropy metrics with other metrics/device parameters to generate a device fingerprint.

FIG. 5 shows different embodiments in which the device integrating the entropy source generates entropy-related metrics.

FIG. 6 shows different embodiments of reporting mechanisms for the entropy metrics.

FIG. 7 shows an example of a close-loop method for halting an entropy source based on using entropy metrics as input.

FIG. 8 shows an example of using these entropy metrics to personalize a certificate generation method.

FIG. 9 shows a network that uses these entropy metrics to suppress weak links within the network.

FIG. 10 shows a network that uses these entropy metrics for preemptive repairing resource assignments.

FIG. 11 shows an example application that collects entropy metrics from the network and displays those in a consumer-friendly approach.

FIG. 12 shows examples of communication networks that implement the methods described in this disclosure.

FIG. 13 shows different embodiments in which the reporting mechanism is implemented into a smartphone.

### DETAILED DESCRIPTION

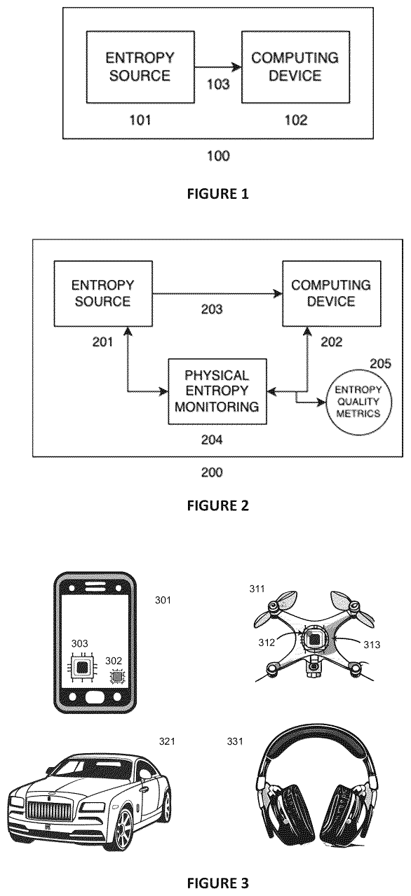

FIG. 1 shows a general, known scheme of operation of the device or system 100 and several examples in which this system is embodied. According to this known scheme, the essential device or system comprises at least one entropy source 101 and one computing device 102. Any metric is done by the computing device 102 on the data stream 103 coming out of the entropy source 101.

In contrast, FIG. 2 shows a general scheme of this disclosure. In this case, the device or system 200 comprises at least one entropy source 201, one computing device 202, a random stream 203 (e.g., one or more random numbers, one or more random characters, etc.) within them as provided by the at least one entropy source 201, and a physical entropy monitoring device or system 204, which measures at will a physical magnitude out of the entropy source 201, and generate from it, either directly or with support of the computing device 202, one or more entropy quality metrics 205. In some examples, the one or more entropy quality metrics 205 are generated before the random stream 203 is produced whereas, in some other examples, the one or more entropy quality metrics are generated after the random stream 203 is produced.

The illustrated device or system 200 shows a single entropy source 201, a single computing device or system 202, a single physical entropy monitoring device or system 204, and a single entropy quality metric 205. However, other embodiments include more than one entropy source 201, and/or more than one computing device or system 202, and/or more than one physical entropy monitoring device or system 204, and/or more than one entropy quality metric 205. For example, in some embodiments, multiple entropy sources 201 are connected modularly to a single or to a plurality of computing device(s) or systems(s) 202.

In the following, and for the sake of simplicity, 202 will be referred only as a device, but it will apply to “device or system”.

In some embodiments, these devices and connections are added or removed dynamically, for example, but without limitation, by the administrator of a network and/or a network management algorithm. As a non-limiting example, one or more backup entropy sources go online if the main one or ones are out of service and go back into backup mode once the main one or ones recover.

In some embodiments, the at least one entropy source 201 comprises one or more Physical Entropy Sources that leverage natural phenomena. Examples of these entropy sources include quantum effects such as phase diffusion or VCSELs. Other examples include—but are not limited to—atmospheric noise, thermal noise, environmental phenomena, chaotic effects, Brownian motion, fluid dynamics, avalanche noise in semiconductors, background radiation, variations in atmospheric conditions, variations in the Earth's magnetic field, and quantum effects such as energy level transitions, photon generation or detection times, or radioactive sources, among others.

In some embodiments, the at least one entropy source 201 comprises one or more Hardware-Based Entropy Sources that utilize hardware components of computing devices. Examples of these entropy sources include—but are not limited to—mouse movements, keyboard typing dynamics, sensor readings, network packet timing, system clock jitter, transistor noise, and physically unclonable functions (PUFs), among others.

In some embodiments, the at least one entropy source 201 comprises one or more Software-Based Entropy Sources that rely on patterns and timing in software activities. Examples include—but are not limited to—process timing variability, thread scheduling patterns, interrupt request timing, and system load variations, among others.

These sources are relevant for cryptographic applications, among others. In some embodiments, these sources are a component of various computing devices, including—but not limited to—servers, desktop computers, and mobile devices. In some of these embodiments, the at least one entropy source 201 and the at least one computing device 202 are embedded into the same physical device. Examples of these include—but are not limited to—a CPU that uses its own thermal noise as an entropy source, or an FPGA that uses its own clock jitter as entropy source.

In some embodiments, the at least one entropy source 201 comprises one or more Biological or Human-Generated Entropy Sources that leverage biological or human actions for randomness. Examples of these sources include—but are not limited to—biometric measurements like heart rate variability, among others.

In some embodiments, the at least one entropy source 201 comprises one or more data streams as input and sources of randomness, for instance those generated from a physical event, including those related to natural or human events or actions. Examples of these sources include—but are not limited to—global financial transactions, stock market fluctuations, live weather data, or global news feeds, among others.

In some embodiments, the at least one entropy source 201 comprises Deterministic Entropy Sources such as deterministic random number generators (DRBGs). These generators use initial seed values to produce sequences of pseudorandom numbers. Examples include—but are not limited to—hash-based DRBGs, block-based DRBGs, and other algorithms like CTR-DRBG and HMAC-DRBG.

In some embodiments, the at least one entropy source 201 comprises Quantum Entropy Sources that utilize quantum effects for randomness. Quantum random number generators (QRNGs) exploit the inherent randomness of quantum processes. Examples of these Quantum Entropy Sources include—but are not limited to—phase-diffusion processes, VCSELs, Photon polarization states, vacuum fluctuations, or quantum computers.

In some embodiments, two or more entropy sources that rely on different origins for their entropy are combined together. Examples of these combinations include—but are not limited to—distributed entropy sources that combine their streams, for example using XOR gates.

In some embodiments, the at least one computing device 202 comprises the entropy source controllers themselves, responsible for managing and controlling entropy sources. Examples of these controllers include—but are not limited to—Application-Specific Integrated Circuits (ASICs), Systems-on-Chip (SoCs), Field-Programmable Gate Arrays (FPGAs), Microcontrollers (uCs), Baseboard Management Controllers (BMCs) and Central Processing Units (CPUs).

In some embodiments, the at least one computing device 202 comprises personal devices, encompassing portable and handheld computing devices for personal tasks and communication. Examples of these personal devices include—but are not limited to—Personal Digital Assistants (PDAs), Wearable Devices like smartwatches and fitness trackers, phones, Smartphones, and Tablets.

In some embodiments, the at least one computing device 202 comprises more general computers, including—but not limited to-desktop computers, laptop computers, embedded systems, servers, datacenters, quantum, thin-client computers, virtual machines, and containers.

In some embodiments, the at least one computing device 202 comprises security and cryptography devices. Examples of these include—but are not limited to—Hardware Security Modules (HSMs), and Trusted Platform Modules (TPMs).

In some embodiments, the at least one computing device 202 comprises quantum technology devices. Examples of these include—but are not limited to—quantum computers, quantum processors, quantum cryptography systems, quantum repeaters, and quantum communication devices.

In some embodiments, the at least one computing device 202 comprises networking and communication devices that manage and facilitate data transmission. Examples of these include—but are not limited to—routers, switches, or firewalls, either real or virtual.

In some embodiments, the at least one computing device comprises one or more specialized computing devices or systems. Examples of these include—but are not limited to—Engine Control Units in vehicles, On-Board Computers in satellites and space-based systems, Application-Specific Integrated Circuits (ASICs), Field-Programmable Gate Arrays (FPGAs), Graphical Processing Units (GPUs), IoT devices, different families of Subscriber Identity Modules (xSIMs), Operational Technology (OT) devices, and Microcontrollers.

A purpose of the at least one entropy source 201 is to generate sequences of random numbers, the quality of which is estimated, in some embodiments, within the at least one computing device 202 using a posteriori metrics and post-processing algorithms. In some other embodiments, the entropy metrics are computed in an a priori manner, that is to say, before the generation of the random numbers themselves. These metrics and post-processing algorithms relate to various aspects of randomness and the quality of either generated or to be generated random number sequences, as well as being related to the device features, operation, or environment.

Regarding the generated random numbers, quality metrics encompass measurements that evaluate properties including one or more of the following: uniformity, independence, complexity, entropy levels, statistical moments, autocorrelation, compression, cryptographic properties, cycle length, and transformation effects.

Examples of quality, independence, and complexity metrics include, but are not limited to, the Frequency Test (Monobit), Long Run Test, and Poker Test for Uniformity: the Runs Up and Down Test and Autocorrelation Test for Independence; and the Entropy Test and Komogorov-Smirnov Test for Complexity.

Examples of entropy metrics include, but are not limited to, Shannon Entropy and Renyi Entropy definitions for Entropy estimation: as well as Mean Length of Code and Lempel-Ziv Compression Algorithm for Compression Test, alongside algorithms like Walsh-Hadamard Transform and Fourier Transform for Transformation Algorithms.

Examples of statistical moments metrics include, but are not limited to, the Mean Test and Standard Deviation Test for Mean and Standard Deviation; and the Third Moment Test (Skewness) and Fourth Moment Test (Kurtosis) for Statistical Moments.

Examples of autocorrelation metrics include, but are not limited to, Autocorrelation at Lag 1 and Autocorrelation at Lag k for Linear Autocorrelation; and Up and Down Runs Test as well as Up and Down Correlation Test for Runs and Correlation Test.

In embodiments in which a priori metrics are computed, the generation of random numbers is posterior to such computation of metrics, which is convenient for establishing whether random numbers are to be generated or not based on the degree of randomness of the random numbers to be generated. Accordingly, when the degree of randomness does not fulfill one or more predetermined criteria, e.g., a degree of randomness does not reach a predetermined randomness threshold, a degree of randomness has reached a convergence within a predetermined convergence threshold, etc., it may be decided that no random numbers are to be generated, either completely because the device or system is not capable of producing random numbers with sufficient randomness or partially. Concerning the latter, the generation of random numbers may be postponed until further a priori metrics computed fulfill the one or more predetermined criteria, at which point it is established that the random numbers that may be generated will have sufficient randomness. Avoiding the generation of random numbers for low randomness values is convenient for not putting at risk the application at hand, particularly, their consumption in cryptography systems, so that the cryptography systems do not receive such random numbers that could potentially lead to insecure environments and/or transmission. The computation of the a priori metrics is based on a status or state of the device or system prior to the generation of random numbers.

Additionally, in some embodiments the selection of metrics and their ranges differ based, for example, on the at least one entropy source 201, the at least one computing device 202 under study, or the surrounding environment. For example, the Shannon entropy of a human entropy source is expected to be lower than that of a purified quantum entropy source.

Additionally, in some embodiments the selection of metrics is flexible, or even is not predefined. An example of these includes, but is not limited to, the leveraging of machine learning models to determine the quality of entropy and using the model as a classifier for good or bad behavior of the at least one entropy source.

Additionally, in some embodiments the at least one entropy source 201, the at least one computing device 202, or both includes at least a sensor, or at least an actuator which, either by themselves or by a suitable method, enable the measurement of magnitudes associated with, among others, operational or environmental factors in each of them.

In some embodiments, various metrics are combined within at least one computing device 202. In some embodiments, these metrics are merged either with other metrics originating from the same computing device 202 or with those measured by at least one physical entropy monitoring device or system 204. Examples of such derived metrics include, but are not limited to, statistical correlation between temperature and entropy quality, frequency distribution analysis of noise levels, time-based entropy rate variations, or physical estimation of entropy bounds.

Additionally, it is possible for the at least one computing device 202 to utilize these metrics to take actions on the at least one entropy source 201. These actions help maintain optimal entropy generation and enhance the system's overall security. Examples of these actions include, but are not limited to, adaptive tuning, threshold-based adjustments, proactive switching, real-time calibration, and proactive tuning of the entropy sources.

Examples of actions include, but are not limited to, adjusting the sampling rate of the at least one entropy source based on temperature fluctuations, applying noise filtering algorithms when noise levels exceed a certain threshold, dynamically selecting different entropy sources based on their current quality assessments, and/or using historical data and trends in entropy quality to predict and prepare for future entropy needs or potential failures.

In some embodiments, the at least one computing device 202 uses other metrics besides those related to the at least one entropy source to take actions on it. As a non-limiting example, the at least one computing device 202 detects a large power fluctuation on its own power line, and the at least one computing device halts the at least one entropy source until the fluctuation disappears as a safety, preemptive action.

FIG. 3 depicts several use cases and embodiments for which monitoring the at least one entropy source is essential to ensure the security, integrity, and performance of devices and systems that rely on random numbers for critical security and communication functions.

A non-limiting embodiment is a smartphone 301, which utilizes at least an entropy source 302 and a computational device 303 to enhance their functionality. Monitoring the entropy source becomes paramount, as it ensures the smartphone can identify any malfunction in the source. Given that the entropy source generates essential random numbers for security applications like cryptographic key generation, a compromised source leads to severe vulnerabilities in communication and data security on the smartphone.

Another non-limiting embodiment is a drone 311, which utilizes at least an entropy source 312 integrated into their logic area 313. Monitoring this entropy source is critical, safeguarding the integrity and security of the drone's operations. The random numbers generated by the entropy source are instrumental in tasks such as navigation and data encryption. Should the entropy source degrade or be compromised, it significantly impacts the drone's capacity to make secure decisions, conduct encrypted communications, and thwart potential takeover attempts by malicious actors.

One embodiment of the disclosure is a vehicle 321, which integrates at least an entropy source along with an internal or external computing device or monitoring system. Monitoring the entropy source within this context ensures internal and external vehicle communications security. As the entropy source contributes to generating cryptographic keys for vehicle security and secure communications, its optimal functioning is paramount. In the event of entropy source failure, attackers could exploit the situation, undermining communications between vehicles, manipulating security systems, and potentially causing accidents or chaos in traffic.

An embodiment of the disclosure is a wired or wireless headphone 331, which incorporates at least an entropy source. These headphones utilize an entropy source to generate random numbers crucial for communication security protocols like encryption and authentication. Monitoring the entropy source within the headphones, for example using the computing device 302 of the smartphone they are connected to 301 is essential, as a compromised source enable attackers to intercept and decode wireless communications, leading to unauthorized access to confidential information and potential privacy breaches. In other embodiments, the entropy source and entropy monitoring system are physically located in a smartphone, music player or generally a computing device where a wireless headphone is connected to. Entropy data is transferred to said headphones or headsets, yet the real-time, online monitoring according to the present disclosure is done within the paired computing device.

An embodiment of this disclosure is a wired or wireless power charger 341, which provides both entropy and power to one or more devices linked to it. Monitoring the entropy source within the charger, for example using an internal computing device 342 or any of the devices 343 linked to it, provides guarantees that the entropy source is working correctly, and thus it can be used by the linked devices as a safe source of entropy. In some embodiments, entropy is obtained from the entropy source and stored in the linked device(s), using it as a local entropy pool, typically used for later consumption in any of the device's entropy-consuming activities, such as the execution of cryptographic protocols.

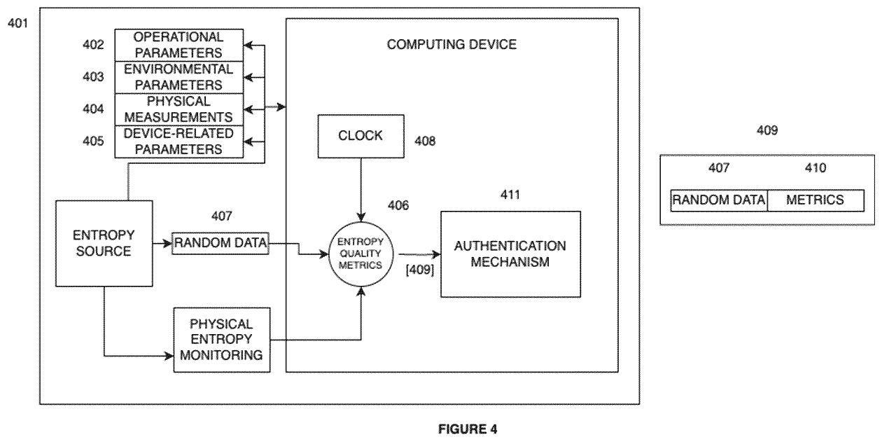

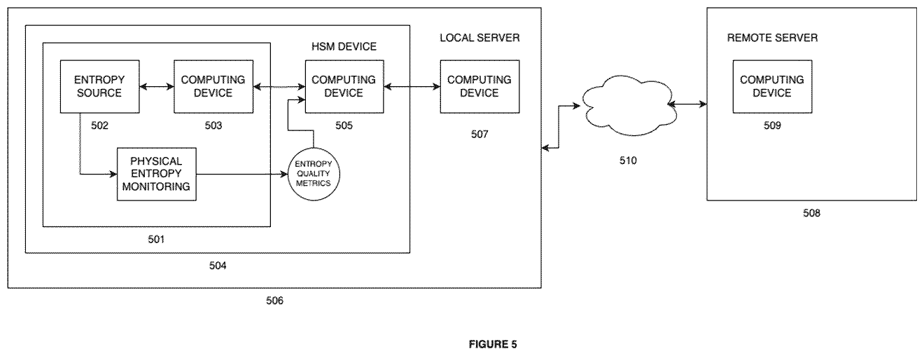

FIG. 4 displays a system combining multiple metrics to achieve a more elaborated functionality. In this scheme, there is a device 401, which comprises at least one entropy source, capable of capturing one or more parameters.

These parameters include in this case one or more of the following: operational, environmental, physical and/or device-related parameters. The illustrated embodiments include the four types of parameters, but other embodiments within the present disclosure include 1, 2, 3 or all 4 of such parameters. In some embodiments, said operational parameters 402, include but are not limited to one or more of the following: voltage, current, and power consumption. In some embodiments, the parameters also pertain to environmental characteristics 403, including, but not limited to, temperature, humidity, and atmospheric pressure. Likewise, the parameters of some embodiments consider also physical measures 404 including, but not limited to, internal temperature, electric fields, and optical power, among other relevant parameters. Similarly, the parameters of some embodiments consider also parameters that are related to the device 405, including but not limited to serial numbers, product models, and vendor IDs.

The device 401, in addition to capturing the random data 407, reserves in some embodiments a header, a tail, or specifically designated positions for the storage of metrics. In some embodiments, these metrics go beyond the metrics mentioned in the previous paragraph 402-405 and, in some embodiments, they also encompass statistics derived from the captured data 406.

Some examples of these metrics include, but are not limited to, conditional min-entropy, Shannon entropy preferably tailored for this device, statistics such as the average value, the ratio of ones to zeros in the string, variability, correlations, autocorrelations, general trends, and other indicators associated with the analysis of the random data.

The established structure 409 allows for any computing device, either internal 401 or external 407, to not only incorporate components such as those that represent the unique signature of the entropy generation 402-406 but also previous elements that provide context 408. These elements include, but are not limited to, timestamps or historical records.

In some embodiments, the complete package 409 contains original or encrypted versions of the entropy section 407. In some embodiments, the corresponding component with the metrics 410 also exists in raw form. In some embodiments, the corresponding component with the metrics 410 is subjected to processing. An instance of such processing involves creating a condensed version of the metrics, such as using a hash function to generate a digest. This is just one example and does not limit other possible approaches.

Subsequent to the processes described, an aspect of this advanced system emerges from utilizing these metrics or digests to reinforce the authenticity of the entropy's origin. The metrics derived from the entropy source 401, whether in their raw, encrypted, or digested form, is strategically employed to function as authentication tokens or keys. In some embodiments, such tokens serve as distinct identifiers, uniquely tying back to the inherent properties of the original entropy.

This authentication methodology leverages a system or a mechanism 411 specifically designed to perform this authentication. In some embodiments, the entropy metrics 410 are used as input to these mechanisms, serving as raw material for validating the integrity and originality of the entropy source 401. In some embodiments, this is carried out by assessing the congruence between the captured metrics and those anticipated from the source.

Mechanisms such as the above include, but are not limited to, cryptographic signature verification techniques, pattern recognition modules, and machine learning algorithms trained on a dataset of genuine entropy metrics. The matching or correlation established through such means confirms either the integrity of the entropy, its authenticity in terms of origin, or both.

In some embodiments, this authentication mechanism 411 is further bolstered by using paired mechanisms, for example, private-public key pairs, where the metrics or their digest form a component of the private key, ensuring the receiver, equipped with the corresponding public key, validates the entropy's source. In some embodiments, such public-private key pairs use also random numbers generated by the entropy source, for which such metrics apply.

FIG. 5 displays various integration schemes that enable using other computer devices 503 besides the computing device in charge of controlling the entropy source, if any.

As previously mentioned, the core component 501 comprises or is communicatively coupled with an entropy source 502 and a computing unit 503 in close or relative proximity. In some embodiments, the core component 501 includes one or more of the elements of the device 401. However, in some embodiments, these entropy sources 501 or 502 are found in larger devices, including, but not limited to, a hardware security module (HSM) 504 or an Entropy-as-a-Service device or system.

In these embodiments, the entropy source 501 or 502 is embedded within a larger device featuring a separate processing unit 505. This unit executes tasks related to the computing unit 503 either partially or entirely.

Consequently, the hardware security module HSM 504 is deemed trustworthy for metric calculations and related operations. In some embodiments, is also serves as the controller for the entropy source. This hierarchical structure is not limited to this example: in some embodiments, it extends beyond the HSM 504.

In some embodiments, the computing devices inside data center 506 housing the HSM 504 or the entropy source 501 are reliable in some capacity. In this case, the computing units of the data center 507 conduct part or all of the required calculations for metric estimation.

In some embodiments, the calculations are performed in another data center 508 equipped with its own computing units 509. In some embodiments, data reside on the same local network, another network 510, and/or a virtual network.

Similarly, alternative examples for the aforementioned devices include, but are not limited to, routers, switches, or firewalls, either physical or virtual.

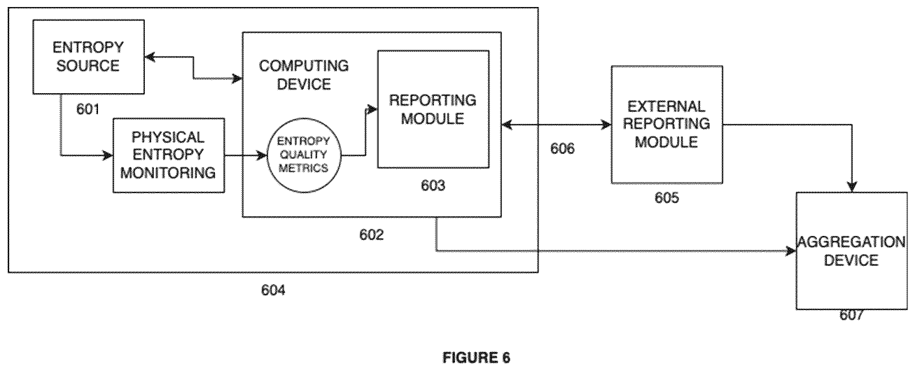

FIG. 6 displays various non-limiting schemes for metric reporting. An entropy source 601 is combined with a computing unit 602 internally housing a reporting module 603. This reporting module 603 fulfills multiple functions, including (but not limited to) storing, aggregating, and transforming results. It is important to note that these are just some of the potential functions that the module can perform. For instance, in some embodiments, this module securely stores encrypted data, aggregate metrics for analysis, and transform raw outcomes into comprehensible representations.

In some implementations, each device 604 possesses its own reporting module. Nevertheless, in alternative variations, this module is located independently from the device 604, at a separate location 605. For example, in an industrial setting, numerous sensors on different machinery report data to a reporting module.

In some embodiments, at least one channel 606 facilitates the transmission of results and metrics from the device 604 to the reporting modules 603, 605. More than one channel 606 might be present, and this variety in configuration contributes to a versatile infrastructure. Non-limiting examples would be Ethernet and WiFi networks.

In some embodiments, more than one of the reporting modules 603, 605 is present, resulting in distinct network configurations where information is captured for subsequent reporting. There are various ways in which this module arrangement is configured. For example, within a corporate network, there might be a reporting module per department, each capturing specific metrics.

In some embodiments, devices including, but not limited to, end-user terminals directly access data through the module 603, if present, from any audit location 605, or other suitable infrastructures for such reporting. It is important to emphasize that these are not the only possible scenarios. For instance, a system administrator could access performance data through the module from inside the local network, while an external auditor could do so from a remote location.

Examples of these infrastructures include, but are not limited to, blockchains, ledgers, and other entities, devices, or systems for network auditing and monitoring. These examples are just a subset of the potential infrastructural choices available. For example, a blockchain that is employed to immutably store metric records, ensuring data integrity. Specialized monitoring devices record and report performance data to a centralized infrastructure for analysis.

Subsequently, in some embodiments, these systems 603, 605 transmit these metrics to additional systems 607, which carry out transformations or aggregations of the metric, creating a cascading process that reaches the end user 607. As a non-limiting example, a data analysis system takes individual metrics from various devices and calculate averages or trends over time. This cascading architecture allows metrics to be transmitted across multiple levels of systems and organizations, ensuring visibility and promoting informed decision-making based on entropy metrics and their quality.

This transmission path is one possible embodiment, and alternative paths are also feasible and fall within the scope of the present disclosure.

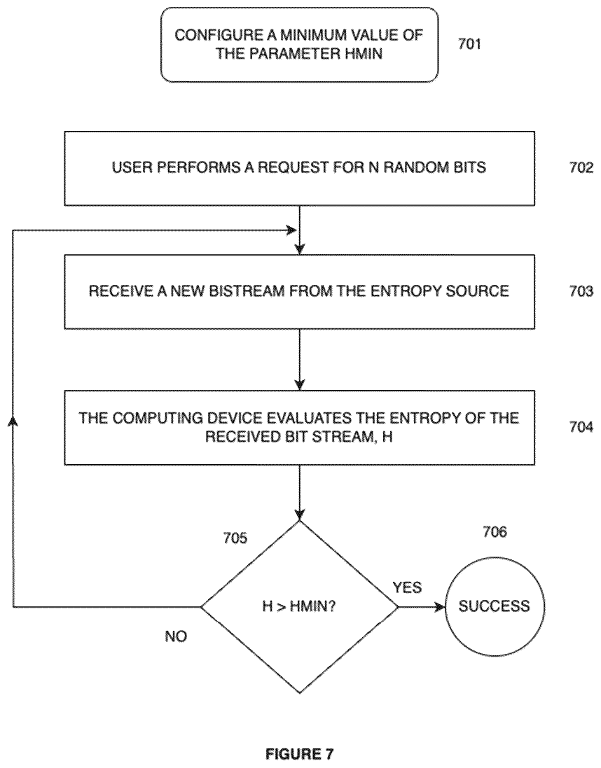

FIG. 7 illustrates one of the embodiments of the methods that influences the behavior of the entropy source using captured metrics.

The method begins by configuring a minimum quality parameter, set at 701. In some embodiments, this parameter is set based on an acceptable error rate or the desired level of entropy, among other factors. In this particular example, minimum entropy per bit is a metric, though in other non-limiting examples any relevant metric is chosen instead or in addition to it, such as the difference between zeros and ones generated in a given stream.

Continuing to point 702, the user requests, via at least one computing device and/or user input means, a certain amount of random bits, denoted as “N”. As non-limiting examples, the user requests 1 bit of entropy, 8 bits of entropy, typical key sizes (such as 128, 256, 512, 1024, 2048, 4096 bits), or even larger chunks, such as 1 Gb, 1 GB, or more. An additional illustrative scenario involves the user requesting a security key for data encryption or a series of random values for simulation purposes.

Subsequently, in 703 the entropy generation system processes the request, retrieving random bits from the entropy source(s) and computes the relevant metric in 704 by means, for example, of the computing device 402. As a non-limiting example, the system might calculate the Shannon entropy to assess the amount of random information in the generated sequence.

At point 705, the corresponding decision is evaluated. If the calculated metric of the generated set is equal to or greater than the minimum strength required by the system, the data is transmitted 706, and the process concludes.

For example, the required minimum strength is set in some embodiments to a predefined value, including 8, 16, 24, 32, 64, 128, 256, 512, 1024, 2048, or 4096 bits of entropy. If the calculated metric is larger than the given required minimum strength, the requirement is met, and the data is sent. In some embodiments, various minimum strength values are predefined based on specific application requirements.

If the requirement is not met, the system takes preventive measures, including a new request for numbers at point 703 and/or pausing the source or reducing the necessary minimum strength. As an example, some embodiments dynamically adjust the minimum strength based on system load or source quality, but other preventive actions are also possible.

This method allows for dynamic influence on the entropy source based on captured metrics and predefined quality needs, creating an adaptable and secure process. It is to be noted that the presented examples are just embodiments and not the exclusive scope covered by the invention.

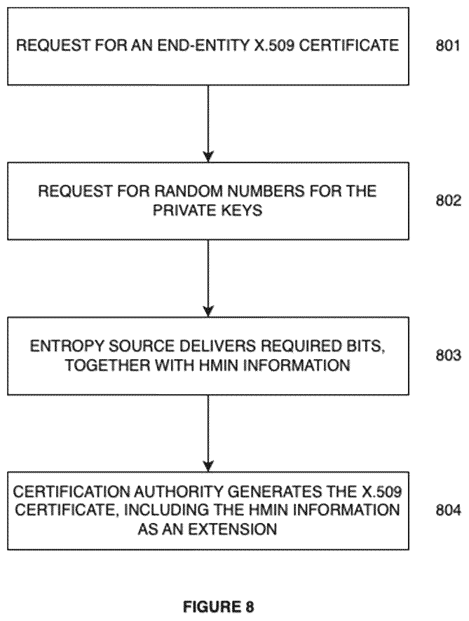

FIG. 8 illustrates a non-limiting example where these metrics find applications to enhance the trust in a given certificate. In this particular case, they are employed as an extension in the X509 certificate generation process, although analogous schemes apply to any certificate or key generation mechanism and they all fall within the scope of the present disclosure.

The process begins with requesting 801 a new X509 certificate, which involves the need 802 for a private key. This private key requires 802 fresh entropy for its generation. This entails a call to the entropy source, which provides 803 the necessary random numbers along with a metric that quantifies the quality of the entropy, the latter being computed before generating the random numbers in some non-limiting examples.

In this non-limiting example, the minimum entropy per bit metric is used. However, some other embodiments use any of the metrics related to the current system state, shared string, or metrics without restrictions, thereby allowing flexibility in choosing the most suitable metric based on system requirements.

Subsequently, the certificate authority proceeds to generate 804 the X509 certificate. During this process, metric information is incorporated as an extension in the certificate. In this instance, the extension contains specific data about the minimum entropy, but it is to be noted that this is just one embodiment of how to present metric information.

This stage culminates in creating a certificate that not only encompasses certificate information (e.g., standard certificate information) but also includes extension details, preferably all extension details. These extension details provide a detailed record of relevant metric information, ensuring that the system was in an optimal state at the time of the certificate request.

Furthermore, in some embodiments, these metrics serve the additional function of distinguishing between different certificates, providing a more robust and detailed approach to identifying and verifying the generated certificates.

For example, comparing the minimum entropy across different certificates yields a comprehensive understanding of the quality of private key generation in each case, helping to determine whether the certificate was generated in a secure and reliable environment and thus improving overall security and reliability in certificate-based systems.

It is important to note that while the example provided offer insights, the possibilities for using these metrics are extensive and adaptable to various contexts and requirements.

The described certificate generation process is conducted by two or more devices forming a system. A first device with one or more computing devices that makes the certificate request 801 and, optionally the random number or fresh entropy request 802: alternatively, the random number or fresh entropy request 802 is made by a third device with one or more computing devices. A second device with one or more computing devices, such as, but without limitation, the device 200 described with reference to FIG. 2, provides 803 the numbers or fresh entropy together with the at least one metric. The first device, the third device or a fourth device with one or more computing devices generates 804 the certificate. In some embodiments, the method just provides the data necessary for the generation 804 of the certificate by a certificate authority, namely, a public/private key pair, and at least one entropy quality metric since the private key already has the fresh entropy, and the certificate generation 804 is just part of some embodiments.

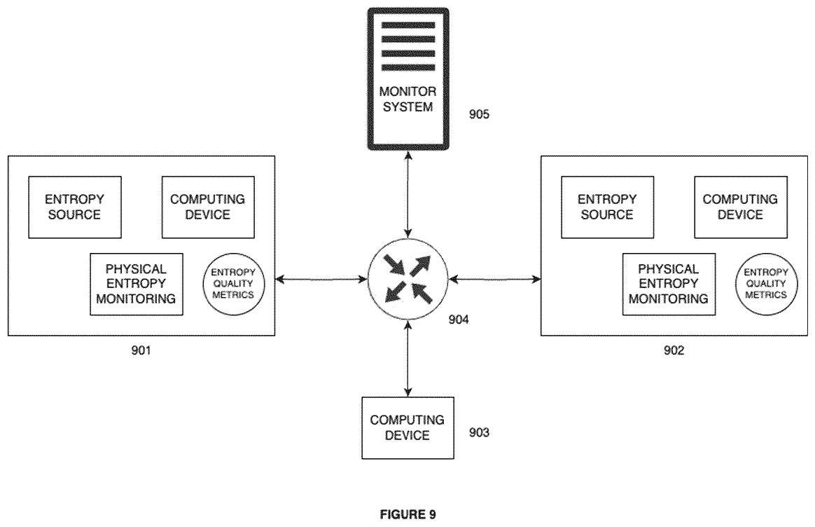

FIG. 9 provides a visual representation of a system, which is adaptable to various embodiments. In an embodiment, a source of entropy is introduced into at least one of the interconnected systems, for example system 901 and system 902. In some embodiments, these systems, composed of a variety of interdependent elements, include additional components in different configurations within a network, such as for example additional computing devices 903. In some embodiments, systems 901, 902 comprise devices such as those from devices or entropy sources 401, 501.

These network elements are interconnected in various ways, ranging from direct connections linking all nodes to more intricate connections through routing 904.

In addition to these systems, a versatile monitoring device or system 905 has access to the network. It collects entropy metrics from all or some of the sources present in the network. This monitoring system operates constantly and dynamically, assessing the behavior of metrics to ensure they remain within predefined performance limits.

Importantly, this monitoring system serves, not only as a passive data collector and manipulator, but as an active system management. As a non-limiting example, if the minimum entropy falls below a predetermined threshold, the system intervenes to suppress using that entropy source for device communications. Also, in some embodiments, this event triggers a recalibration process if entropy drops below a critical threshold, among other actions. Within this network, the multiple nodes 901,902,903 and diverse connections, ranging from the simplest to routing-based 904, form a structure that is both dynamic and interdependent. Also, in some embodiments, this event may trigger importing entropy from a trusted source outside the main network.

Thanks to the monitoring of entropy metrics, either continuously, one-shot, or on a schedule, an evaluation of system quality is achievable. In some embodiments, active measures are applied to maintain optimal performance and security levels.

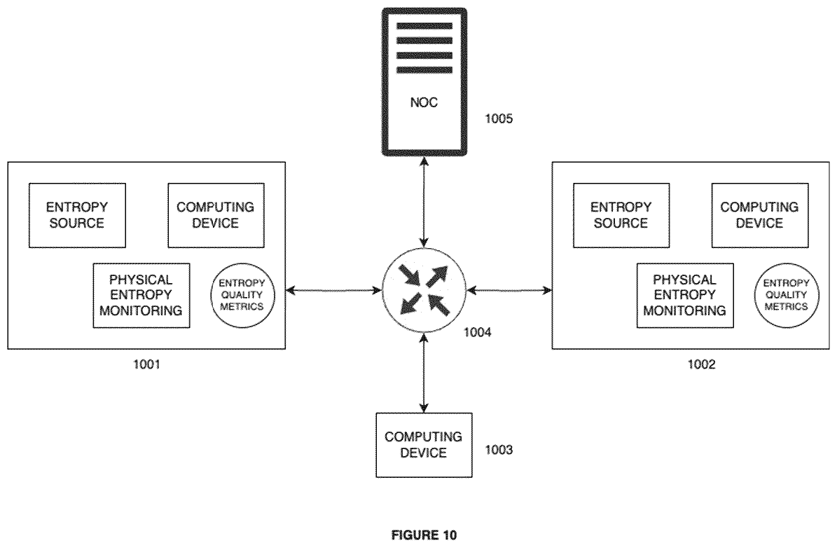

FIG. 10 depicts an alternative embodiment for entropy collection. In this depiction, multiple interconnected devices 1001, 1002, 1003 are connected to a network 1004. In some embodiments, systems 1001, 1002 comprise devices such as those from devices or entropy sources 401, 501. Additionally, in this particular scenario, a Network Operations Center (NOC) 1005 is featured, overseeing the system's environment. This NOC plays a proactive role, performing measurements that encompass both environmental factors and those related to the entropy source and its associated parameters. By way of example, the NOC 1005 can measure variables such as ambient temperature and the rate of entropy generation.

The primary function of the NOC is to take action when deviations, anomalies, or values that fall outside predefined ranges are detected. Specific, non-limiting instances of these actions include identifying whether an entropy source has experienced more than two failures within a predetermined period of time, for example but without limitation, the last 30 days, or if three entropy sources from the same provider have failed in the previous month. In response to these situations, a multitude of responses can be initiated within the network. For instance, if recurring failures are detected in a particular entropy source, the system seamlessly transitions to another operational source.

These measures encompass a wide range of possibilities, including, but not limited to, recalibrating systems, selectively inhibiting specific nodes, exploring alternative routing paths, considering different entropy sources than the originally employed ones, and implementing other pertinent measures.

For instance, when a defective node is identified, the network the node belongs to dynamically reroutes traffic through an available alternate path. In the same or other embodiments, if one or more of failures are detected in an entropy source from a provider, the NOC halts all entropy sources from that provider and notifies the system administrator for action, detecting and addressing potential issues before they escalate into critical failures, and thus enhancing the security and overall performance of the system.

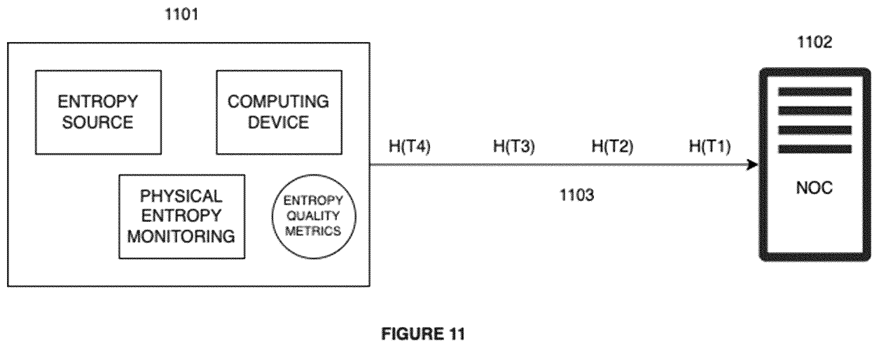

FIG. 11 exemplifies a use case in which an entropy source 1101 interacts with a computing system 1102) that serves as a monitoring point. This entropy source generates various metrics H(t0), H(t1), H(t2) . . . at different moments t0, t1, t2, . . . . Using these metrics 1103, the computing system 1102 applies techniques including one or more of the following machine learning, regression, or prediction. These techniques enable the detection, reporting, or implementation of actions based on patterns identified within the system. This way, the system can react proactively or palliatively, following the previously presented approaches in earlier figures or other suitable strategies.

This approach demonstrates how metrics and historical data is leveraged to anticipate a range of future behaviors of the system, with each example being just one embodiment among many possible scenarios. The ability to predict potential deviations or issues allows for more effective decision-making, and the implementation of appropriate preventive or corrective actions, which vary depending on specific circumstances.

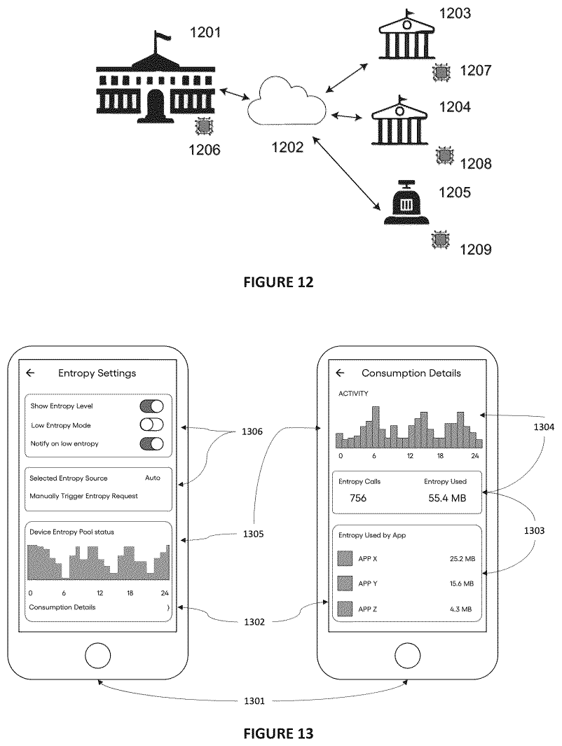

FIG. 12 shows an embodiment of a communication network that implement the methods described in this disclosure.

In this embodiment, a network of embassies is depicted, underscoring communication originating from a central command position 1201. This communication propagates through a network 1202 interconnecting multiple embassies and command posts 1203, 1204, 1205. The security of communications among these embassies hinges on entropy sources both at the source 1206 and within each embassy 1207, 1208, 1209. In some embodiments, this communication feasibility depends on entropy quality levels, and predefined or dynamic thresholds, like 0.90 or 0.95, dictate communication conditions.

However, the scope of the strategy extends beyond embassy networks, encompassing analogous domains like police, military, and intelligence networks. In a police network scenario, the strategy safeguards communication confidentiality between law enforcement units and command centers through the use of entropy sources and entropy quality metrics.

The strategy's versatility extends into both public and private networks, finding application in Internet of Things (IoT) and Operational Technology (OT) systems, among others. In an IoT scenario, devices communicate within a network, guided by entropy metrics generated by devices and network infrastructure. In an OT scenario, physical devices are connected to a network, guided by entropy metrics generated by devices and network infrastructure.

The strategy's applicability extends to financial and business sectors, particularly in Virtual Private Network (VPN) setups. In a VPN context, secure communication between branches and the central headquarters is ensured through entropy sources at both ends. Similarly, in telecommunication internodes and intranodes, the strategy safeguards communication between nodes via adaptable entropy metrics. Other network types include, but are not limited to, Software-Defined Wide Area Networks (SDWAN) and Secure Access Service Edge (SASE) networks.

The concept further extends to critical infrastructure environments. In ensuring hospital security, confidential communication among medical units and control rooms is reinforced by dependable entropy sources. Electrical grids depend on the strategy to ensure communication integrity among distribution stations, and water treatment plants use entropy sources to secure data confidentiality during varied processes.

In the financial domain, banking networks implement this strategy to secure transactions and communication between branches and the central bank. Emergency systems benefit from secure communication between coordination centers and response units.

The concept's applicability extends further to space communication. Satellites equipped with entropy sources establish communication with Earth only if the entropy source's quality meets predefined standards. This ensures communication integrity in space missions. Even in air traffic control the strategy's adaptability safeguards communication between control towers and aircraft.

The disclosed reporting strategy, anchored in entropy sources and associated metrics, finds utility across a myriad of scenarios, spanning diplomatic, critical infrastructure, and space communication domains.

Additionally, the concept's applicability extends to existing protocols such as TLS or SSH. In some embodiments, the reporting information is used as nonce for the required handshake process.

FIG. 13 illustrates some specific realizations for which these entropy monitoring concepts are provided to an end-user of one of the communication networks previously mentioned. For these realizations, a system or device 1301 includes a reporting interface 1302.

In some embodiments, the system or device 1301 acts as an endpoint node within a network. Non-limiting examples of such devices include smartphones, routers, laptops, IoT devices (e.g., smart thermostats, security cameras), dedicated servers, virtual machines, containers, and/or any system or apparatus designed to receive, transmit, or process data within a network environment.

In some embodiments, the system or device 1301 serves another role within a network. Examples of these include, but are not limited to, intermediate nodes (such as switches, routers, or gateways), centralized servers, network management systems, and/or network appliances (such as firewalls or load balancers).

The reporting interface 1302 provides a way for user interaction and data visualization. This interface may be realized in different ways, depending on the system or device. In some embodiments, such as a smartphone, non-limiting examples of this interface are an app or at least one menu within the smartphone's settings. In other embodiments, such as IoT devices, non-limiting examples of the interface are as simple as an LED which lights up when the entropy levels within the device are sufficient.

Other embodiments of this reporting interface 1302 involve (but are not limited to) Graphical User Interfaces, Command-Line interfaces, instant messaging services, SMS messages, an IP which provides an API endpoint, a web-app, or any other interactive medium suitable for displaying and, if necessary, allowing the manipulation of the presented data and/or the control of the device behavior regarding entropy gathering and/or consumption.

The design and functionalities of the reporting interface 1302 are adaptable based on the requirements of the network environment and the specific needs of the users. The interface may support customizable widgets, alerts, and real-time updates, providing an efficient way for users to monitor, analyze, and react to the entropy-related data and metrics derived from the system or device 1301.

In some embodiments, the reporting interface 1302 comprises ways to show entropy consumption results 1303. This component captures and displays the amount or rate of entropy consumed by various processes or components within the system or device 1301. These results are represented in diverse formats, including—but not limited to—charts, graphs, numerical values, and/or any other visual representation deemed effective for the users. The entropy consumption results provide insights into the randomness, unpredictability, and overall health of data processes and serve as an essential metric for ensuring secure and efficient operations within the network.

In some embodiments, the reporting interface 1302 comprises aggregated entropy metrics 1304 within the device. These metrics encompass, as non-limiting examples, averages, peaks, troughs, or any derived data that offers value to the monitoring objectives. By providing aggregated data, users quickly discern patterns, anomalies, or trends without diving into the granular details, thus aiding in swift decision-making processes.

In some embodiments, the reporting interface 1302 comprises time-dependent metrics 1305 that allow users to monitor entropy variations over specific durations. These time-dependent metrics offer a temporal perspective on the entropy dynamics of the system or device 1301. Such a perspective enables users to understand how entropy-related attributes evolve over time, identifying trends, periodic behaviors, and potential anomalies.

Time-dependent metrics 1305 are represented in various formats, including—but not limited to—line graphs, histograms, time series plots, or heat maps. In some embodiments, users select specific time intervals, ranging from milliseconds to hours, days, weeks, months, or years, depending on the granularity or overview desired. For instance, an administrator might want to observe entropy levels in real-time during a security incident or analyze monthly trends for strategic planning.

Several aspects of entropy can be explored through these time-dependent metrics 1305. They might reveal, for example, the frequency of entropy highs and lows over given periods, the rate of entropy consumption or generation over time, or the seasonality or cyclic patterns of entropy levels. In some embodiments, these insights are used to anticipate potential challenges, optimize the overall performance and security of the network environment, and make informed decisions based on historical and real-time entropy data.

To support these, and any other potential use cases, the reporting interface 1302 may allow users to set up alerts or notifications based on these time-dependent metrics. As a non-limiting example, if entropy drops below a certain threshold for a prolonged period, an alert is triggered. Advanced customization options are available, enabling users to fine-tune entropy-related notifications based on individual preferences, historical entropy data, and predictive analytics to enhance relevance and user-centricity. In some embodiments, the alert is sent to an Incident Management System.

In some embodiments, the reporting interface 1302 is imbued with enhanced notification functionalities to bolster user interaction and engagement in relation to entropy monitoring. In some embodiments, context-aware notifications are utilized, which adeptly modify the presentation, timing, and content of notifications to align with the user's real-time context and usage patterns. In some embodiments, interactive notifications are utilized, allowing users to execute immediate entropy-related adjustments directly within the notification interface. In some embodiments, adaptive notification functionalities are integrated, categorizing and prioritizing notifications to reflect the severity, urgency, and potential repercussions of the entropy conditions identified. In some embodiments, proactive notification functionalities are utilized, anticipating and alerting users to potential entropy anomalies or issues preemptively. In some embodiments, collaborative notifications are enabled, allowing for integration with third-party applications or services.

In addition to visual representations, in some embodiments the reporting interface 1302 offers export functionalities, allowing users to extract any of these metrics 1303-1305 data for further analysis using external tools or for record-keeping purposes.

In some embodiments, the reporting interface 1302 comprises control devices elements 1306 to facilitate user-driven adjustments and management of the system or device's entropy-related functions. These control elements grant users the ability to modify and fine-tune the behavior of the system or device 1301, enabling optimal performance, security, and resource management based on the dynamic needs of the network environment.

Control devices 1306 comprise a variety of user interface components. Non-limiting examples include buttons, toggles, dropdown menus, sliders, and touchscreens. In some embodiments, the usability and design of these controls is tailored to accommodate the expertise and preferences of different users, from basic users to advanced administrators.

Some key functionalities offered by the control devices 1306 include, but are not limited to, entropy consumption modes (such as high-efficiency, balanced, or low-entropy consumption), entropy source selection (such as selecting from a list or dropdown menu of available sources), force entropy source usage (such as overriding automatic or default selections), threshold alerts (such as setting specific entropy thresholds), entropy pool management (such as adjusting the size, refresh rate, or partitioning of entropy pools), manual refresh or gather (such as manually prompting the system or device 1301 to gather or refresh entropy), logging and reporting preferences (such as logging frequency and report metrics), and update and calibration controls (such as recalibrating or updating entropy mechanisms).

In view of the above-described implementations of subject matter this application discloses, the following list of examples of subject matter is provided, wherein one feature of an example in isolation or more than one feature of an example, taken in combination and, optionally, in combination with one or more features of one or more further examples are further examples also falling within the disclosure of this application:
Example 1 is an apparatus or a system, including: at least one entropy source: at least one computing device and/or at least one physical entropy monitoring device: the at least one physical entropy monitoring device is configured to measure at least one physical parameter of the at least one entropy source, and at least one of the at least one computing device or the at least one physical entropy monitoring device is configured to compute at least one entropy quality metric at least based on the at least one physical parameter.
In Example 2, the subject matter of Example 1 includes the at least one entropy source has a status or state which is conditioned to the entropy quality metric included in a given set of acceptable values. Examples of such status or state include, but are not limited to, operational, non-operational, or degraded. Examples of such acceptable values include, but are not limited to, a conditional min-entropy value above 0.5, 0.75, 0.8, 0.85, 0.90, 0.95, 0.99 bits per bit.
In Example 3, the subject matter of any one of Examples 1-2 includes the entropy source is configured to modify an operation thereof according to a physical state of the entropy source.
In Example 4, the subject matter of any one of Examples 1-3 includes the at least one computing device being configured to report the entropy quality metrics to at least one reporting module, such as at least one reporting module of the apparatus or system.
In Example 5, the subject matter of any one of Examples 1-4 includes the at least one computing device being configured to report the at least one entropy quality metric together with an entropy thereof, for example report them to at least one reporting module, which, in some examples, is comprised in the apparatus or system and, in some other examples, is external to the apparatus or system.
In Example 6, the subject matter of any one of Examples 1-5 includes the at least one entropy source comprising at least one quantum entropy source.
In Example 7, the subject matter of any one of Examples 1-6 includes the at least one entropy source being configured to provide an entropy, such as a fresh entropy.
In Example 8, the subject matter of any one of Examples 1-7 includes the at least one entropy quality metric being at least one a priori metric.
In Example 9, the subject matter of any one of Examples 1-8 includes the at least one computing device and/or the at least one entropy source being configured to generate random numbers when the at least one entropy quality metric fulfills one or more predetermined criteria.
In Example 10, the subject matter of any Example 9 includes the at least one of the at least one computing device or the at least one physical entropy monitoring device being configured to compute the at least one entropy quality metric a plurality of times, and the at least one computing device and/or the at least one entropy source being configured to not generate the random numbers until the at least one entropy quality metric of one or more times fulfills one or more predetermined criteria.
Example 11 is a method for enhancing trust in certificate generation, including: providing, by an apparatus or system according to the present disclosure or as described in the subject matter of any one of Examples 1-10, fresh entropy and at least one entropy quality metric: generating a public/private key pair such that at least the private key is generated using the fresh entropy provided; and creating a certificate containing the at least one of the entropy quality metric provided.
In Example 12, the subject matter of Example 11 includes the certificate created further containing certificate information (e.g., standard certificate information).
In Example 13, the subject matter of any one of Examples 11-12 includes the at least one entropy quality metric provided is provided based on a status or state of the apparatus or system, and in particular of the at least one entropy source.
In Example 14, the subject matter of any one of Examples 11-13 includes measuring at least one physical parameter of the at least one entropy source of the apparatus or system, and computing at least one entropy quality metric at least based on the at least one physical parameter.
In Example 15, the subject matter of any one of Examples 11-14 includes conducting the method as a computer-implemented method.
Example 16 is a computer program product including instructions which, when the program is executed by at least one computing device, cause the at least one computing device to carry out the steps of a method according to the present disclosure or as described in the subject matter of any one of Examples 11-15.
Example 17 is a non-transitory computer-readable storage medium having stored thereon a computer program product as described in the subject matter of Example 16.
Example 18 is a smartphone, including: at least one computing device: a display, a battery, a casing: a wireless connectivity system: an apparatus or system according to the present disclosure or as described in the subject matter of any one of Examples 1-10; and at least one reporting interface configured to provide user interaction and data visualization, such as, e.g., data relating to entropy monitoring: optionally, the smartphone includes an operating system and/or the at least one computing device be configured to run an operating system.
In Example 19, the subject matter of Example 18 includes the at least one computing device and/or the apparatus or system being configured to calculate entropy consumption results, aggregated entropy metrics, and/or time-dependent metrics of entropy dynamics of the smartphone; and/or the at least one reporting interface being configured to show the entropy consumption results, the aggregated entropy metrics, and/or the time-dependent metrics.
In Example 20, the subject matter of any one of Examples 18-19 includes the at least one reporting interface comprising one or more control devices configured to facilitate user-driven adjustments of entropy-related functions.
In Example 21, the subject matter of any one of Examples 18-20 includes the at least one reporting interface being configured to provide context-aware notification functionalities based on real-time context and usage patterns of a user.
Example 22 is a communication network, including: a plurality of network nodes; and a set of links between network nodes of the plurality of network nodes for data transmission: at least one network node of the plurality of network nodes includes an apparatus or system according to the present disclosure or as described in the subject matter of any one of Examples 1-10, and the plurality of network nodes is configured to transmit data between network nodes of the plurality of network nodes and/or to at least one external gateway, with the transmitted data being at least protected with one or more entropy quality metrics: optionally, at least one apparatus or system is configured to apply protection with the one or more entropy quality metrics to data to be transmitted.
In Example 23, the subject matter of Example 22 includes at least one network node of the plurality of network nodes comprising a smartphone according to the present disclosure or as described in the subject matter of any one of Examples 18-21.
In Example 24, the subject matter of any one of Examples 22-23 includes one or more network nodes of the plurality of network nodes being configured to report entropy quality metrics to at least one device when connected to the network.
Example 25 is a system including: at least an entropy source, and at least one computing device, such at least one computing device being configured to receive a cryptographic certificate. Examples of these certificates include, but are not limited to, X.509 certificate. In some examples, the certificate contains standard information including, but not limited to, the version of the certification protocol, the serial number of the certificate, the signature algorithm used for the signature, the issuer of the certificate (e.g., one or more computing devices of a certification authority), the validity period of the certificate, and the signature itself. In some embodiments, at least one additional extension is added to the certificate, the at least one additional extension containing at least one entropy metric.
In Example 26, the subject matter of Example 25 includes the at least one computing device being at least one first computing device, and the system also including at least one second computing device being configured to issue the cryptographic certificate. The at least one second computing device may be configured to request random numbers to the entropy source for generating a private key.
Example 27 is a method including measuring at least one physical parameter of at least one entropy source of an apparatus or system, and computing at least one entropy quality metric at least based on the at least one physical parameter, the at least one entropy quality metric being computed by at least one computing device and/or at least one physical entropy monitoring device of the apparatus or system.
In Example 28, the subject matter of Example 27 includes the at least one entropy quality metric being at least one a priori metric.
In Example 29, the subject matter of any one of Examples 27-28 includes generating random numbers when the at least one entropy quality metric fulfills one or more predetermined criteria, and not generating the random numbers otherwise.

It should be noted that the above-described examples of the present solution are for the purpose of illustration. Although the solution has been described in conjunction with specific examples thereof, numerous modifications are possible without materially departing from the teachings of the subject matter described herein. Other substitutions, modifications and changes may be made without departing from the spirit of the present solution.

All of the features and applications disclosed in the present disclosure (including any accompanying claims, abstract and drawings), and/or all of the parts of any method or process so disclosed, may be combined in any combination, except combinations where at least some of such features and/or parts are mutually exclusive.

1-18. (canceled)

19. An apparatus, comprising:
an entropy source;
one or more processors; and
a physical entropy monitor configured to measure a physical parameter of the entropy source,
wherein the one or more processors or the physical entropy monitor are configured to compute an entropy quality metric based on the physical parameter.

20. The apparatus of claim 19, wherein the entropy quality metric is an a priori metric.

21. The apparatus of claim 19, wherein the entropy source is configured to modify an operation thereof according to a physical state of the entropy source.

22. The apparatus of claim 19, wherein the one or more processors are configured to report the entropy quality metric to a reporting module.

23. The apparatus of claim 19, wherein the one or more processors are configured to report the entropy quality metric together with an entropy thereof.

24. The apparatus of claim 19, wherein the entropy source comprises a quantum entropy source.

25. The apparatus of claim 19, wherein the entropy source is configured to provide fresh entropy.

26. The apparatus of claim 19, wherein the one or more processors comprise one or more:
Application-Specific Integrated Circuits (ASICs);
Systems-on-Chip (SoCs);
Field-Programmable Gate Arrays (FPGAs);
Microcontrollers (uCs);
Baseboard Management Controllers (BMCs);
Central Processing Units (CPUs); and/or
quantum processors.

27. A method for enhancing trust in certificate generation, the method comprising:
providing, by an apparatus according to claim 19, fresh entropy and at least one entropy quality metric;
generating a public/private key pair, wherein the generating comprises at least generating a private key of the public/private key pair using the fresh entropy of the providing; and
creating a certificate, based on the public/private key pair generated, containing the at least one entropy quality metric of the providing.

28. The method of claim 27, wherein the at least one entropy quality metric is an a priori metric.

29. The method of claim 27, wherein the certificate created further contains an extension with the at least one entropy quality metric of the providing.

30. The method of claim 27, wherein the at least one entropy quality metric is provided based on a state of the entropy source of the apparatus.

31. A smartphone comprising:
a display;
a battery;
a casing;
an operating system;
a wireless connectivity system;
an entropy source;
one or more processors;
a physical entropy monitor configured to measure a physical parameter of the entropy source, wherein the one or more processors or the physical entropy monitor is configured to compute an entropy quality metric based on the physical parameter of the entropy source; and
a reporting interface configured to provide user interaction and data visualization relating to entropy monitoring.

32. The smartphone according to claim 31, configured to show entropy consumption results, aggregated entropy metrics, and/or time-dependent metrics of entropy dynamics of the smartphone.

33. The smartphone according to claim 31, wherein the reporting interface comprises one or more control devices configured to facilitate user-driven adjustments of entropy-related functions.

34. The smartphone according to claim 31, wherein the reporting interface is configured to provide context-aware notification based on a real-time context and usage patterns of a user.

35. A communication network, comprising:
a plurality of network nodes, and
a set of links between the plurality of network nodes for data transmission,
wherein at least one network node of the plurality of network nodes comprises an apparatus according to claim 19, and wherein the plurality of network nodes is configured to transmit data between network nodes and/or to at least one external gateway, the data being at least protected with one or more entropy quality metrics.

36. The communication network of claim 35, wherein at least one network node of the plurality of network nodes comprises a smartphone, comprising:
one or more first processors,
a display, a battery, and a casing,
an operating system,
a wireless connectivity system,
a reporting interface configured to provide user interaction and data visualization relating to entropy monitoring, and
an apparatus comprising:
an entropy source,
one or more second processors, and
a physical entropy monitor,
wherein the physical entropy monitor is configured to measure at least one physical parameter of the entropy source, and at least one of the one or more second processors or the physical entropy monitor are configured to compute an entropy quality metric at least based on the physical parameter.

37. The communication network of claim 36, The communication network according to claim 16, wherein one or more network nodes of the plurality of network nodes is configured to report the one or more entropy quality metrics to at least one device when connected to the network.
